(19) United States
(12) Patent Application Publication
(10) Pub. No.: US 2004/0078214 A1
(43) Pub. Date: Apr. 22, 2004

(54) Product recommendation in a network-based commerce system

(76) Inventors: Leonard Robert Speiser, Redwood City, CA (US); Nicholas David Posner, Menlo Park, CA (US); Jannie Lai, Monte Sereno, CA (US); Louis M. Monier, Menlo Park, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/666,681

(22) Filed: Sep. 18, 2003

Related U.S. Application Data
(60) Provisional application No. 60/420,199, filed on Oct. 21, 2002.

(51) Int. Cl. G06F 17/60

(52) U.S. Cl. 705/1

(57) ABSTRACT

A method and system of providing listing recommendations to users of a network-based commerce system including a plurality of listings arranged in a plurality of divisions is described. The method includes identifying a division of the plurality of divisions based on user interaction with the network-based commerce system, and identifying at least one frequently used search term associated with the division. A link is provided to the user to listings associated with the frequently used search term. The search terms may be ranked by retrieving frequently used search terms from a first memory location and determining a number of listings in each division associated with each frequently used search term. Each frequently used search term may then be ranked based on the number of listings in each division.

### CROSS REFERENCE TO RELATED APPLICATION

The present application claims the benefit of the filing date of U.S. provisional application serial No. 60/420,199, filed Oct. 21, 2002.

### FIELD OF THE INVENTION

The present invention relates generally to the field of electronic commerce, and more specifically to a method and system to recommend listings in a network-based commerce system.

### BACKGROUND

More and more Internet users are realizing the ease and convenience of buying and selling online via a network-based commerce system. Certain such commerce systems are focused on person-to-person trading, and collectors, hobbyists, small dealers, unique listing seekers, bargain hunters, and other consumers, are able to buy and sell millions of listings at various online shopping sites. Such systems also support business-to-person and business-to-business commerce.

The success of a networked-based commerce system may depend upon its ability to provide a user-friendly environment in which buyers and sellers can conduct business efficiently. Current network-based commerce systems have certain limitations in the manner in which they present information to users.

### SUMMARY OF THE INVENTION

A method and system of providing listing recommendations to users of a network-based commerce system including a plurality of listings arranged in a plurality of divisions is described. The method includes identifying a division of the plurality of divisions based on user interaction with the network-based commerce system, and identifying at least one frequently used search term associated with the division. A link is provided to the user to listings associated with the frequently used search term. The search terms may be ranked by retrieving frequently used search terms from a first memory location and determining a number of listings in each division associated with each frequently used search term. Each frequently used search term may then be ranked based on the number of listings in each division.

### BRIEF DESCRIPTION OF THE DRAWINGS

The invention is now described, by way of example, with reference to the accompanying diagrammatic drawings in which the same reference numerals indicate the same or similar features.

FIG. 1 is block diagram illustrating an exemplary network-based commerce system, in accordance with the invention.

FIG. 2 is a database diagram illustrating an exemplary database, maintained by, and accessed via, a database engine server, which at least partially implements and supports the network-based commerce system.

FIG. 3A is a diagram illustrating popular search term location logic, according to an exemplary embodiment of the present invention, to determine and rank popular search terms to be utilized in recommending listings to users of the network-based commerce system.

FIG. 3B is a diagram illustrating popular search term presentation logic, according to an exemplary embodiment of the present invention, to provide recommendations to users of a network-based commerce system.

FIG. 4A provides an exemplary embodiment of a popular search term table.

FIG. 4B provides an exemplary embodiment of a popular search term ranking table.

FIG. 4C is a popular search term list provided to illustrate an example of the contents of the popular search term ranking table.

FIG. 5 is a flowchart illustrating a method, according to an exemplary embodiment of the present invention, of determining popular search terms to be included within a group of preliminary search terms utilized by a network-based commerce system in generating recommendations to a user interacting with listings in the network-based commerce system.

FIG. 6 provides an exemplary embodiment of a preliminary popular search term table.

FIG. 7 provides an exemplary embodiment of a filtered popular search term table.

FIG. 8 is a flowchart illustrating a method, according to an exemplary embodiment of the present invention, of filtering popular search terms utilized by a network-based commerce system in generating recommendations to a user interacting with listings in the network-based commerce system.

FIG. 9 is a flowchart illustrating a method, according to an exemplary embodiment of the present invention, of assigning each of the popular search terms to a category in the network-based commerce system.

FIG. 10 provides an exemplary embodiment of an approved popular search term table.

FIG. 11 is a flowchart illustrating a method, according to an exemplary embodiment of the present invention, of providing a user with the opportunity to view listings based on the supply and demand of the listings in the network-based commerce system.

FIG. 12A is a user interface, according to an exemplary embodiment of the present invention, to display selectable popular search terms to a user.

FIG. 12B illustrates an exploded view of a groups window included within the user interface of FIG. 12A.

FIG. 13 shows a diagrammatic representation of a machine in the exemplary form of a computer system within which a set of instructions, for causing a machine to perform any one of the methodologies discussed herein, may be executed.

### DETAILED DESCRIPTION

A method and system automatically to recommend listings, and rank search terms, in a network-based commerce system is described. The recommended listings and ranked search terms may be based on supply and demand of the listings. In the following description, for purposes of explanation, numerous specific details are set forth in order to provide a thorough understanding of the present invention. It will be evident, however, to one skilled in the art that the present invention may be practiced without these specific details.

### Terminology

For the purposes of the present specification, the term “listing” may refer to any description, identifier, representation or information pertaining to a listing, service, offering or request that is stored within a network-based commerce system or facility. In one embodiment, the listings may include products (e.g., goods and/or services) and the listing may be an auction or fixed-price offering, an advertisement, or a request for a listing or service.

The term “listing recommendation” includes any instance of a listing (or information about associated listings) being presented to a user by a network-based commerce system. The word “term” includes any criteria, textual, numeric, visual, audible or otherwise, submitted by users searching a network-based commerce system. It is to be appreciated that the word “term” and the word “phrase” may be used interchangeably and shall be taken to include search terms using multiple words or characters. Thus, a search entries such as “men's clothing” and “shirts” would both be referred to a search terms. Broadly, any entry by a user into a search field may thus define a search “term” or “phrase”.

The phrase “frequently used search term” is intended to include, for example, terms that are frequently entered by users when conducting searches for listings. The frequently used search terms need not be limited to terms used in a specific network-based commerce facility or system but may include terms used in other facilities. Thus, frequently used search terms include popular terms that would generally be associated by users with one or more listings. Thus, the words “frequently used” and the word “popular” may be used synonymously.

### Transaction Facility

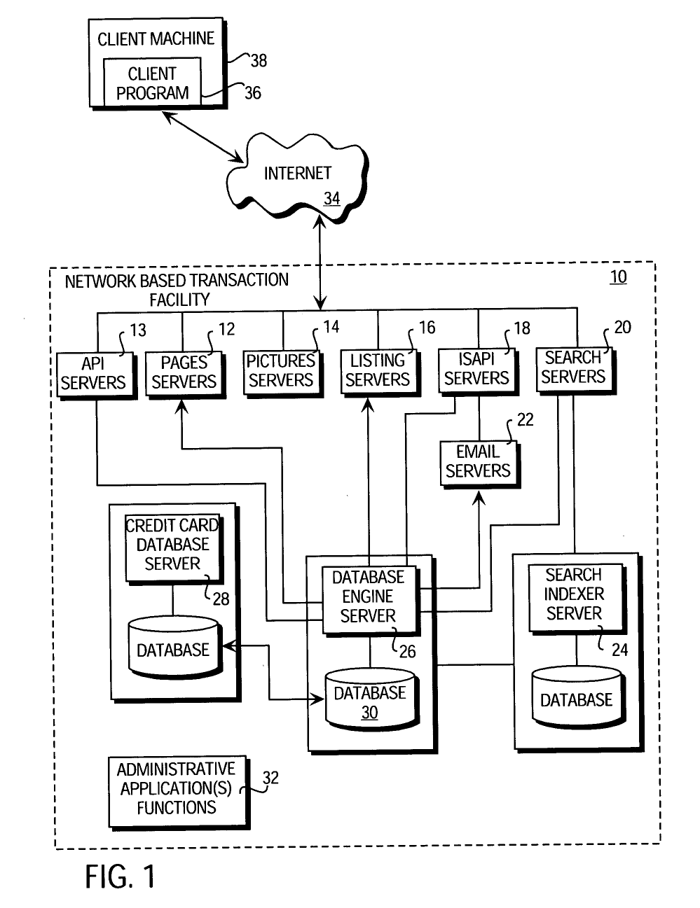

FIG. 1 is block diagram illustrating an exemplary network-based commerce system 10. While an exemplary embodiment of the present invention is described within the context of the network-based commerce system 10, the invention may find application in many different types of computer-based, and network-based, facilities (commerce, transaction or otherwise).

The exemplary network-based commerce system 10 includes one or more of a number of types of front-end servers that each includes at least one Dynamic Link Library (DLL) to provide certain functionality. Page servers 12 deliver web pages (e.g., mark-up language documents), picture servers 14 dynamically deliver images to be displayed within Web pages, listing servers 16 facilitate category-based browsing of listings, and search servers 20 handle search requests to the network-based commerce system 10 and facilitate keyword-based browsing of listings. ISAPI servers 18 provide an intelligent interface to a back-end of the network-based commerce system 10. E-mail servers 22 provide, inter alia, automated e-mail communications to users of the network-based commerce system 10. Administrative application functions 32 facilitate monitoring, maintaining, and managing the network-based commerce system 10. API servers 13 provide a set of functions for querying and writing to the network-based commerce system 10. API functions are called via HTTP transport protocol and information may be sent and received using a standard XML data format. Applications utilized to interact (e.g., upload transaction listings, review transaction listings, manage transaction listings, etc.) with the network-based commerce system 10 may be designed to use the API servers 13. Such applications may be in HTML form or may be a CGI program written in C++, Perl, Pascal, or any other programming language. Exemplary API functions are more fully described in co-pending U.S. patent application Ser. No. 09/999,618, incorporated herein by reference.

The page servers 12, API servers 13, picture servers 14, listing servers 16, ISAPI servers 18, search servers 20, e-mail servers 22 and a database engine server 26 may individually, or in combination, act as a communication engine to facilitate communication between, for example, a client machine 38 and the network-based commerce system 10; act as a transaction engine to facilitate transactions between, for example, the client machine 38 and the network-based commerce system 10; and act as a display engine to facilitate the display of listings between, for example, the client machine 38 and the network-based commerce system 10.

The network-based commerce system 10 may also include one or more of a number of types of back-end servers. The back-end servers are shown, by way of example, to include the database engine server 26, a search index server 24 and a credit card database server 28, each of which may maintain and facilitate access to a respective database. In one embodiment, the back-end servers are included within a storage area network (SAN).

The network-based commerce system 10 may be accessed by a client program, such as a browser 36 (e.g., the Internet Explorer distributed by Microsoft Corp. of Redmond, Wash.) that executes on the client machine 38 and accesses the network-based commerce system 10 via a network such as, for example, the Internet 34. Other examples of networks via which a client may access the network-based commerce system 10 include a wide area network (WAN), a local area network (LAN), a wireless network (e.g., a cellular network), a Public Switched Telephone Network (PSTN) network, or the like.

### Database Structure

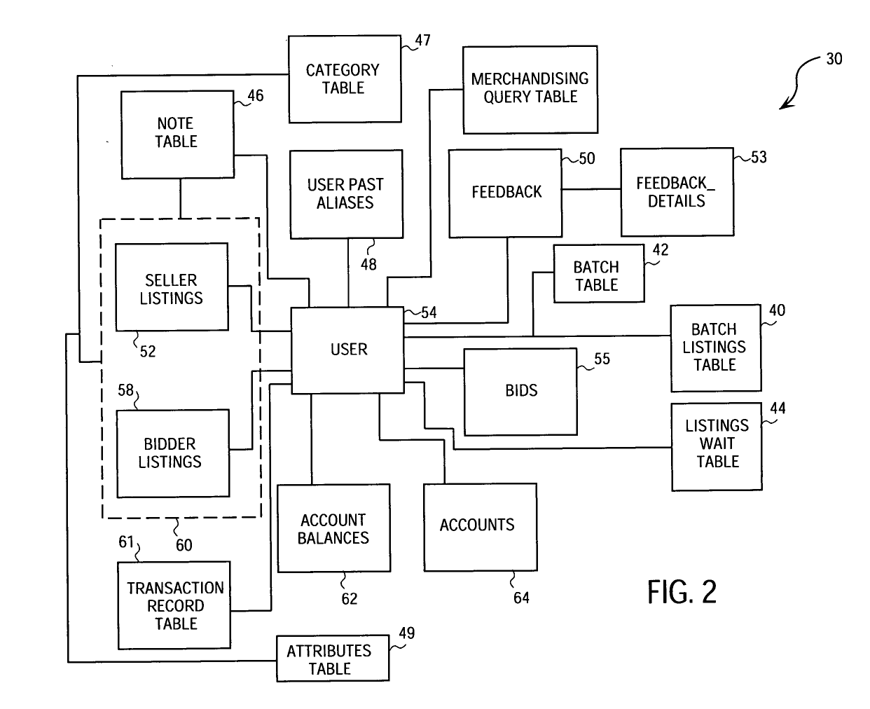

FIG. 2 is a database diagram illustrating an exemplary database 30 (see also FIG. 1), maintained by and accessed via the database engine server 26, which at least partially implements and supports the network-based commerce system 10. In one embodiment, the database engine server 26 maintains two databases. A first database may be maintained for listing (or offering) information that is not included within a virtual “store”, and a second database may store offerings that are presented via virtual “stores” supported by the network-based commerce system 10. In one embodiment the structure of these databases may be substantially the same, but may differ in that the tables of the “store” database may include a number of additional fields to facilitate the virtual “stores”. A general discussion of the basic structure of a single database 30 is presented below, but is also applicable when two (or more) databases are present.

The database 30 may, in one embodiment, be implemented as a relational database, and include a number of tables having entries, or records, that are linked by indices and keys. In an alternative embodiment, the database 30 may be implemented as a collection of objects in an object-oriented database.

A user table 54 (see FIG. 2) may contain a record for each user of the network-based commerce system 10. A user may operate as a seller, buyer, or both, when utilizing the network-based commerce system 10. The database 30 may include listings tables 60 that may be linked to a user table 54. The listings tables 60 may include a seller listings table 52 and a bidder listings table 58. A user record in the user table 54 may be linked to multiple listings that are being, or have been, listed or offered for sale via the network-based commerce system 10. A link may indicate whether the user is a seller or a bidder (or buyer) with respect to listings for which records exist within the listings tables 60.

The listings may be arranged into divisions that, in one embodiment, are in the form of categories. Accordingly, the database 30 also includes one or more category tables 47. Each record within the category table 47 may describe a respective category. Thus, in one embodiment, the system 10 provides the capability to arrange listings in one or more categories. These categories may be navigable (e.g. browsed) by a user of the network-based commerce system 10 to locate listings in specific categories. Thus, categories provide a mechanism to group and thus browse listings, in addition to locating listings using an alphanumeric search mechanism provided by the search servers 20. In one embodiment, the category table 47 describes multiple, hierarchical category data structures, and includes multiple category records, each of which describes the context of a particular category within each one of the multiple hierarchical category structures. For example, the category table 47 may describe a number of real, or actual, categories to which listing records, within the listings tables 60, may be linked.

The database 30 also includes one or more attributes tables 49. Each record within an attributes table 49 may describe a respective attribute. In one embodiment, the attributes table 49 describes multiple, hierarchical attribute data structures, and includes multiple attribute records, each of which describes the context of a particular attribute within the multiple hierarchical attribute structures. For example, the attributes table 49 may describe a number of real, or actual, attributes to which listing records, within the listings tables 60, may be linked. Also, the attributes table 49 may describe a number of real, or actual, attributes to which categories, within the category table 47, may be linked.

The database 30 also includes a note table 46 populated with note records that may be linked to one or more listing records within the listings tables 60 and/or to one or more user records within the user table 54. Each note record within the note table 46 may include, inter alia, a comment, description, history or other information pertaining to a listing being offered via the network-based commerce system 10, or to a user of the network-based commerce system 10.

A number of other exemplary tables are also shown to be linked to the user table 54, namely a user past aliases table 48, a feedback table 50, a feedback details table 53, a bids table 55, an accounts table 64 and an account balances table 62. The database 30 is also shown to include a batch table 42, a batch listings table 40, a listings wait table 44, and a merchandising query table 45.

One embodiment of the invention relates to generating listing recommendations based on a combination of past bidding/purchasing history and popular search phrases or terms (economic demand for listings) at the network-based commerce system 10. Popular search phrases or terms may be computed in a data warehouse. For example, the data warehouse may identify the most frequently used or popular search phrases or terms across, for example, a selected number of sites associated with the network-based commerce system 10. Frequently used or popular search terms may be stored in the data warehouse as data indicating which searches are most popular. Popular search terms may then be periodically retrieved by a production facility, e.g., on a daily basis, where the production facility may project the popular search terms against an inventory of listings. The projection may be based on a search process for each category at each level. All popular search terms that match at least a predetermined or selected number of listings (e.g., 50) listed within a category may be stored together with an identity of the matched listings. Thus, each category may have some number of popular search terms (from 0 to a predetermined or selected number) assigned to it. Further, a measurement indication of the popularity of the frequently used or popular search term, in a particular category, may also be provided.

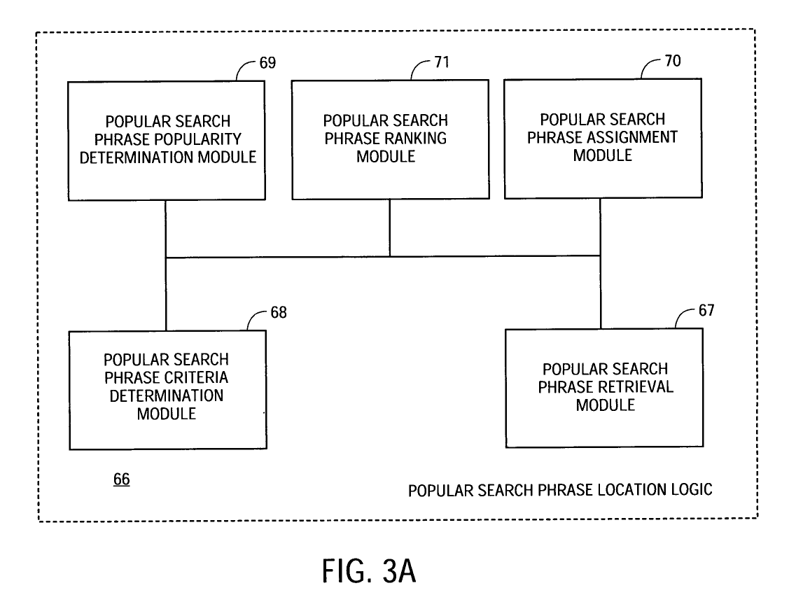

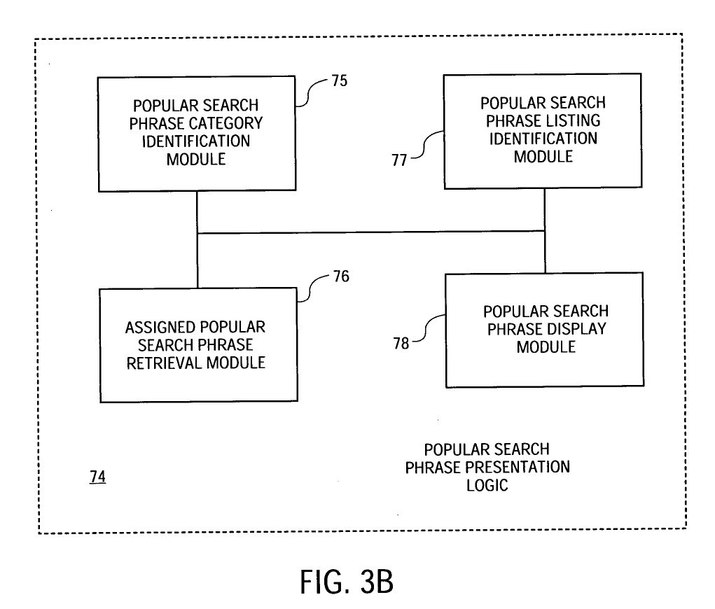

FIG. 3A is a diagram illustrating popular search phrase or term location logic 66, according to an exemplary embodiment of the present invention, to determine and rank popular search terms to be utilized in recommending listings to users of the network-based commerce system 10. The recommendation may be based on, for example, supply and demand of the listings. The popular search term location logic 66 includes popular search term retrieval module 67, a popular search term criteria determination module 68, a popular search term popularity determination module 69, a popular search term assignment module 70, and a popular search term ranking module 71.

The popular search term retrieval module 67 is provided to retrieve popular search term from a memory location. The popular search term criteria determination module 68 may determine if the popular search term meets one or more a predetermined or selected criterion. The popular search term popularity determination module 69 is provided to determine the number of listings that will be returned in response to a search utilizing the popular search term, wherein each category of the network-based commerce system 10 may be searched and the number of listings returned is determined per category. The popular search term assignment module 70 may assign the popular search term that returned, or is associated with, a predetermined or selected number of listings per category to a second memory location. The popular search term ranking module 71 may rank popular search terms within the second memory location. In one embodiment, the popular search term ranking module 71 ranks the popular search term per category against other popular search terms within the popular search terms category. The popular search terms may be ranked in ascending or descending order. The first and second memory location may be provided in any database included within the system 10.

FIG. 3B is a diagram illustrating popular search term presentation logic 74, according to an exemplary embodiment of the present invention, to provide recommendations to users of the network-based commerce system 10 based, for example, on the supply and demand of listings within the network-based commerce system 10. The popular search term presentation logic 74 includes a popular search term category identification module 75, an assigned popular search term retrieval module 76, a popular search term listing identification module 77, and a popular search term display module 78.

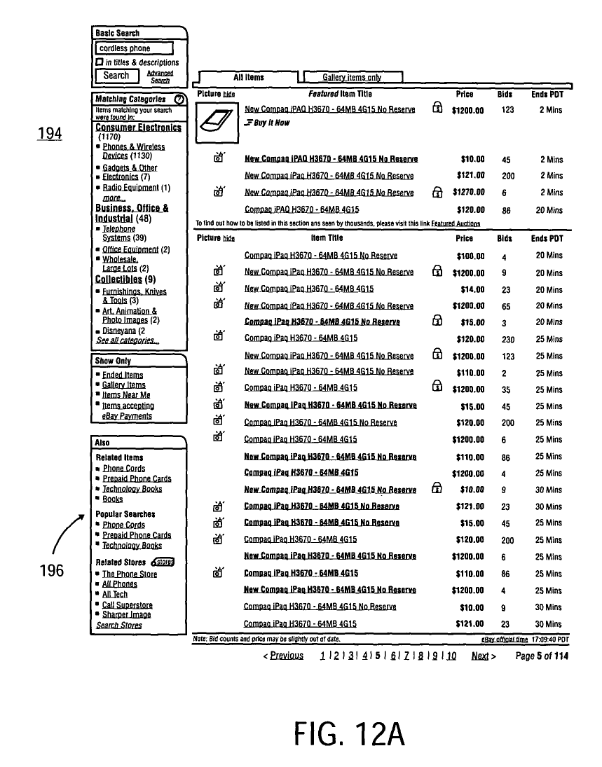

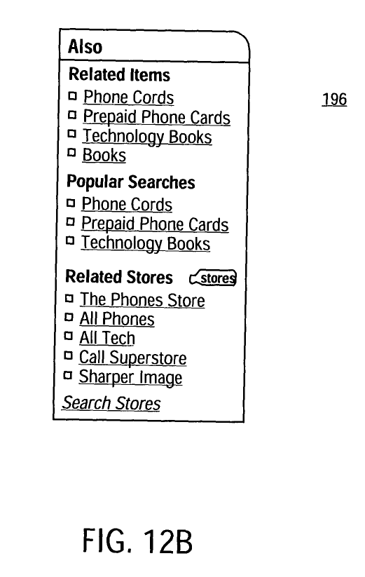

The popular search term category identification module 75 may identify a category associated with a listing or listings that a user is interacting with (e.g. browsing, searching or the like) in the network-based commerce system 10. The assigned popular search term retrieval module 76 may retrieve a predetermined number of popular search terms assigned to the category. The popular search term listing identification module 77 may identify one or more listings in the identified category that would be returned in response to a search utilizing one or more popular search terms. The popular search term display module 78 is provided to display the popular search terms as a hyperlink to listings identified in response to the search utilizing each of predetermined number of popular search terms. In one embodiment, a predetermined number of listings are associated with the hyperlink. The popular search terms may be displayed within a user interface, as described below with reference to FIGS. 12A and 12B.

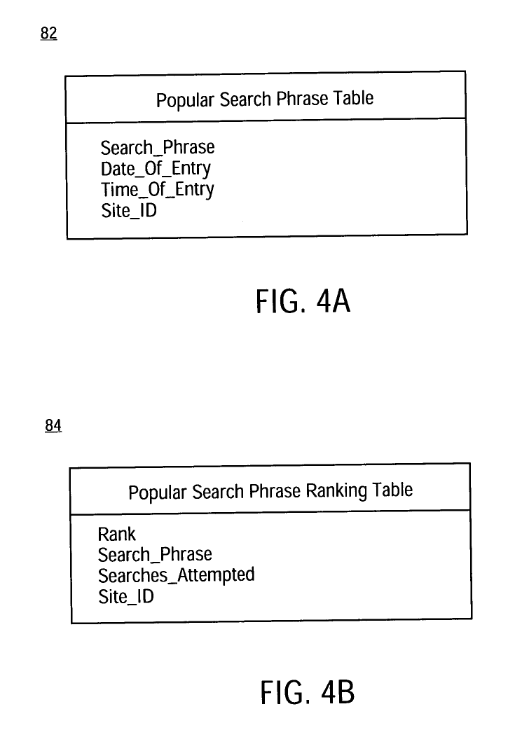

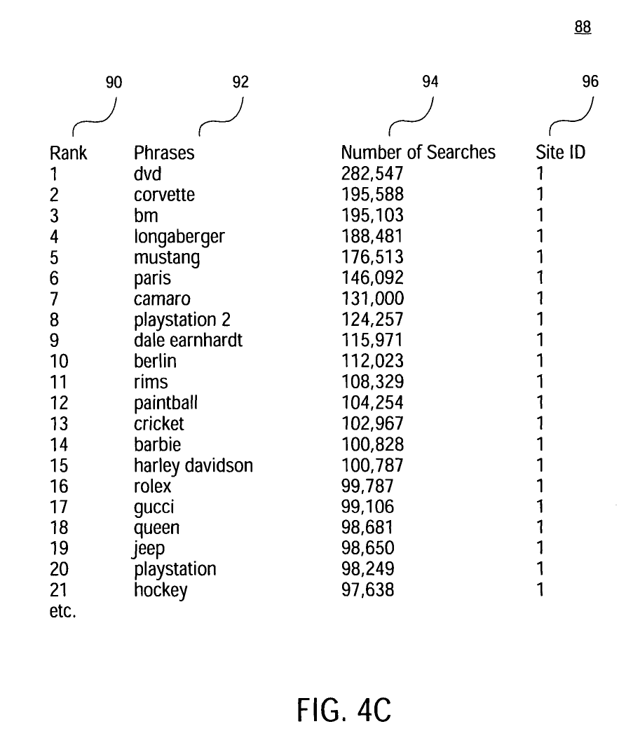

In one embodiment, a record of each popular search term is stored in a Popular Search Term table 70, an example of which is provided in FIG. 4A. The Popular Search Term table 70 is shown, by way of example, to include a Search_Term field, a Date_Of_Entry field, a Time_Of_Entry field, and a Site_ID field.

In one exemplary embodiment, information relating to ranking popular search terms with regard to the frequency with which they are attempted or used, is stored in a Popular Search Term Ranking table 80, an example of which is provided in FIG. 4B. The Popular Search Term Ranking table 80 is shown, by way of example, to include a Rank field, a Search_Term field, a Searches_Attempted field, and a Site_ID field.

FIG. 4C shows an exemplary Popular Search Term list 88 that illustrates an example of the contents of the Popular Search Term Ranking table 80 (see FIG. 4B). The first column in the Popular Search Term list 88 provides a Rank 90 associated with the popular search terms included within the list 88. The second column provides popular search terms 92 included within the list 88. The third column provides a Number of Searches 94 attempted at the network-based commerce system 10 (or at multiple different systems) using the popular search terms 92, for example, within a predetermined amount of time (e.g., the last two weeks). The fourth column provides a site identification or Site ID 96 associated with a site at which the popular search terms 92 are entered. In one embodiment, the network-based commerce system 10 may include multiple sites, wherein each site is identified by specific criterion (e.g., country, language, type of listings offered, etc.). In one embodiment, the Site ID 96 provides the identity of client machines where the network-based commerce system 10 exists within a peer-to-peer network.

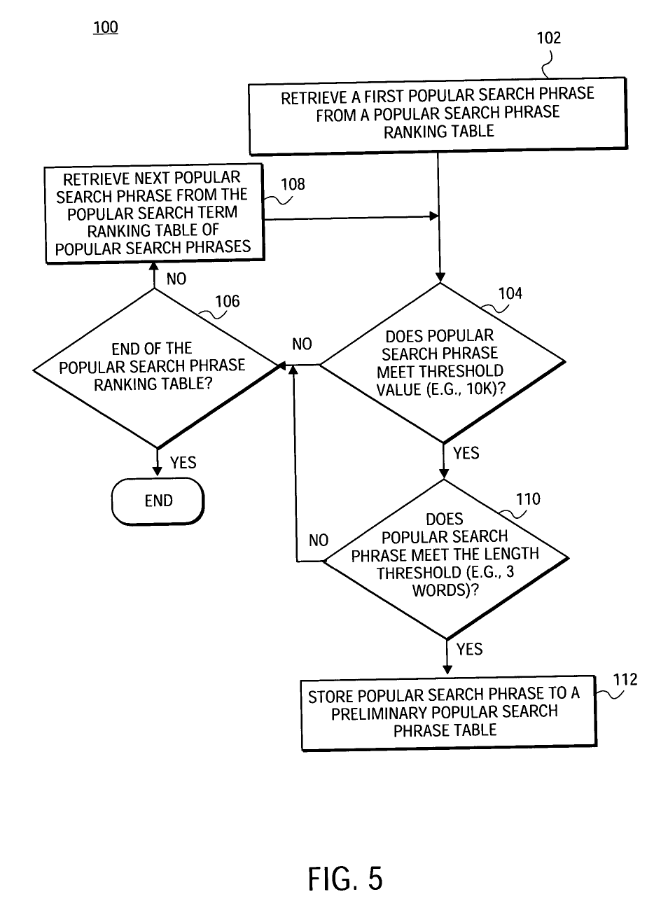

FIG. 5 is a flowchart illustrating a method 100, according to an exemplary embodiment of the present invention, of determining one or more popular search terms or phrases to be included within a group of preliminary search terms utilized by a network-based commerce system 10 in generating recommendations to a user interacting with listings in the network-based commerce system 10.

At block 102, a first popular search term is retrieved from the Popular Search Term Ranking table 80 (see FIG. 4A).

At decision block 104, a determination is made as to whether the popular search term meets a predetermined threshold value or popularity. For example, a determination may be made as to whether the popular search term has been attempted or used a predetermined number of times (e.g., 10,000) within a designated or selected period of time (e.g., the previous two weeks). In one embodiment, only popular search terms that use no special characters (e.g., *, -, (,),etc.) are considered. In another exemplary embodiment, popular search terms that use special characters are also considered.

If the frequently used or popular search term does not meet the threshold value, then at decision block 106 a determination is made as to whether there are any other popular search terms in the Popular Search Term Ranking table 80. If there are additional popular search terms in the Popular Search Term Ranking table 80, then at block 108 the next popular search term is retrieved from the Popular Search Term Ranking table 80. This process may be repeated until all popular search terms in the Popular Search Term Ranking table 80 have been considered.

Returning to decision block 104, if a determination is made that the popular search term meets the threshold value (e.g., 10,000) then a determination is optionally made at decision block 110 as to whether the search term meets a length threshold (e.g., popular search term includes 3 or more words). However, in other embodiments of the invention a decision may be made at block 110 as to whether the popular search term meets a maximum length thereby to limit a maximum length of a popular search term. Restricting the length of a popular search term may ensure that the popular search term fits into an associated field of a navigation interface. However, in certain embodiments, no determination of the popular search term meeting a length threshold need be made.

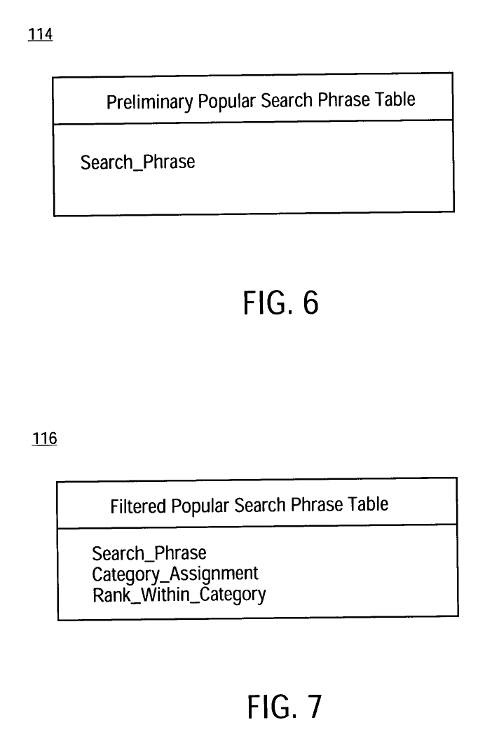

At block 112, popular search terms that meet the length threshold are stored in a Preliminary Popular Search Term table 114. FIG. 6 provides an exemplary embodiment of the Preliminary Popular Search Term table 114 that includes a Search_Term field.

The popular search phrases included within the Preliminary Popular Search Term table 114 may be filtered and then assigned to a category. In one embodiment, a record of each popular search term is stored in a Filtered Popular Search Term table 116, an example of which is provided in FIG. 7.

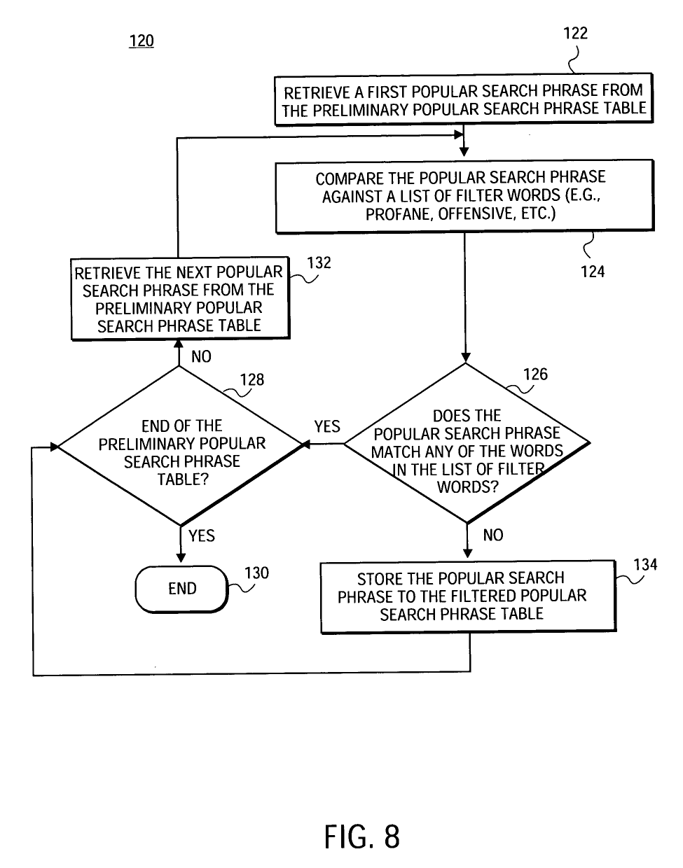

FIG. 8 is a flowchart illustrating a method 120, according to an exemplary embodiment of the present invention, of filtering popular search phrases or terms. At block 122, a first popular search term is retrieved from the Preliminary Popular Search Term table 114.

At block 124, the popular search term is compared against a list of reference or filter words (e.g., Profane, Offensive, etc.). The list of filter words may be modified to add or remove filter words. The list of filter words may be stored in a table and, in one embodiment, the list of filter words is provided in a “dictionary” which is periodically updated (e.g. every 2 hours). A common dictionary (e.g. including words in multiple languages) may be provided for multiple international sites of the network-based commerce system 10.

At decision block 126, a determination is made as to whether the popular search term matches any of the words in the list of filter words.

At decision block 128, if the popular search term does match one of the filter words, then a determination is made as to whether the end of the Preliminary Popular Search Term table 114 has been reached. If the end of the Preliminary Popular Search Term table 114 has been reached, the method 120 ends at block 130. If the end of the Preliminary Popular Search Term table 114 has not been reached, at block 132, the next popular search phrase or term is then retrieved.

Returning to decision block 126, if a determination is made that the popular search term does not match any of the words in the list of filter words, then at block 134, the popular search term is stored to the Filtered Popular Search Term table 116 (see FIG. 7).

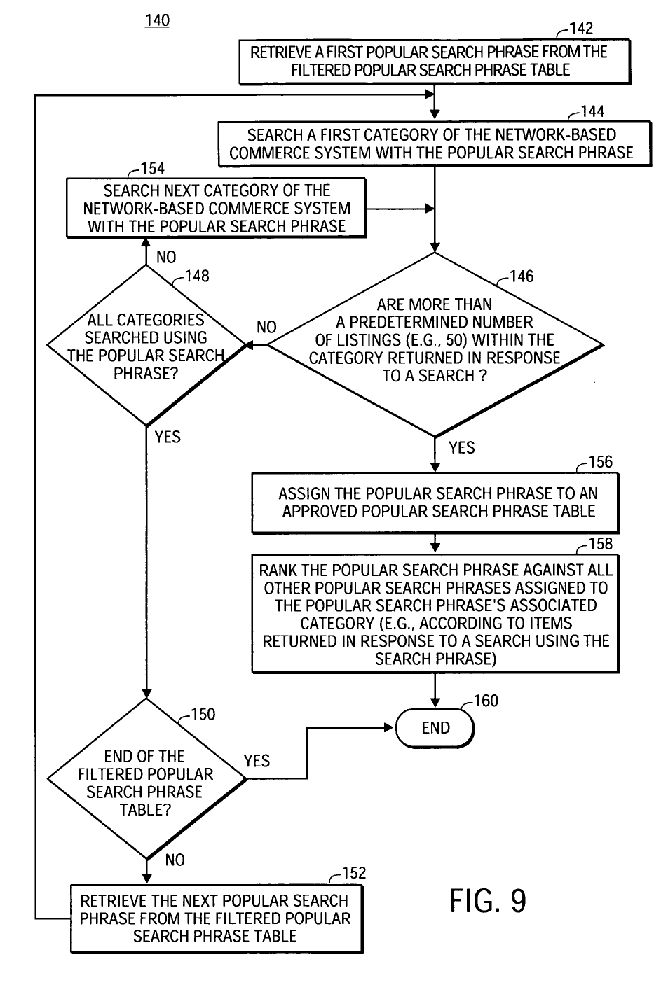

After filtering the popular search terms, a determination is made with regard to category assignment. As described below with reference to FIG. 9, in one embodiment category assignment is based on supply and demand of listings returned in response to searches within each category using each of the popular search phrases or terms.

FIG. 9 is a flowchart illustrating a method 140, according to an exemplary embodiment of the present invention, of assigning each of the popular search terms to a category in the network-based commerce system 10.

At block 142 a first popular search term from the Filtered Popular Search Term table 116 is retrieved.

At block 144 a first category of the network-based commerce system 10 is searched with the popular search term.

At decision block 146 a determination is made as to whether there are more than a predetermined number or occurrences of listings (e.g., 50 products and/or items in a particular category) returned as a result of the search utilizing the popular search term.

If less than the predetermined number of listings was returned at decision block 146, then at decision block 148 a determination is made as to whether all categories within the network-based commerce system 10 have been searched using the popular search term. At decision block 148, if all categories within the network-based commerce system 10 have been searched using the popular search term, then a determination is made at decision block 150 as to whether there are additional popular search terms in the Filtered Popular Search Term table 116. If there are additional popular search terms, then at block 152 the next popular search term is retrieved from the Filtered Popular Search Term table 116 and the method 140 returns to block 144. If the end of the Filtered Popular Search Term table 116 has been reached, then at block 160 the method 140 ends.

Returning to decision block 148. If a determination is made that that all categories (or any number of selected categories or divisions) within the network-based commerce system 10 have not been searched using the popular search term, then at block 154 the next category within the network-based commerce system 10 is searched using the popular search term and the method 140 returns to decision-block 146.

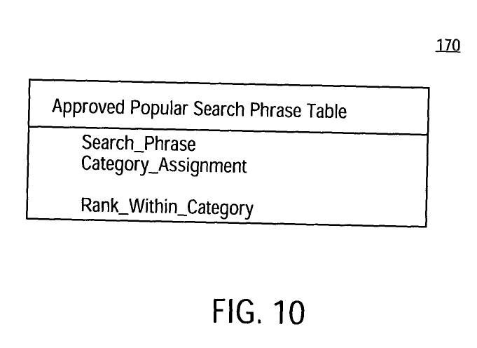

Returning to decision block 146, if more than a predetermined number or occurrences of listings within a category are returned, then at block 156 the filtered popular search term is assigned to an Approved Popular Search Phrase table 170 (see FIG. 10). In addition, a record associated with the popular search phrase's Category Assignment field in table 170 is updated to reflect the identity of the category within which the listings (e.g., goods and/or services) were returned.

At block 158, the popular search phrase or term is ranked against all other popular search terms associated within the category. In one exemplary embodiment, the popular search terms are ranked according to listings returned in response to a search using the popular search term. In one embodiment, the rank of a search term within a category is stored in a Rank_Within_Category field of the Filtered Popular Search Term table 116.

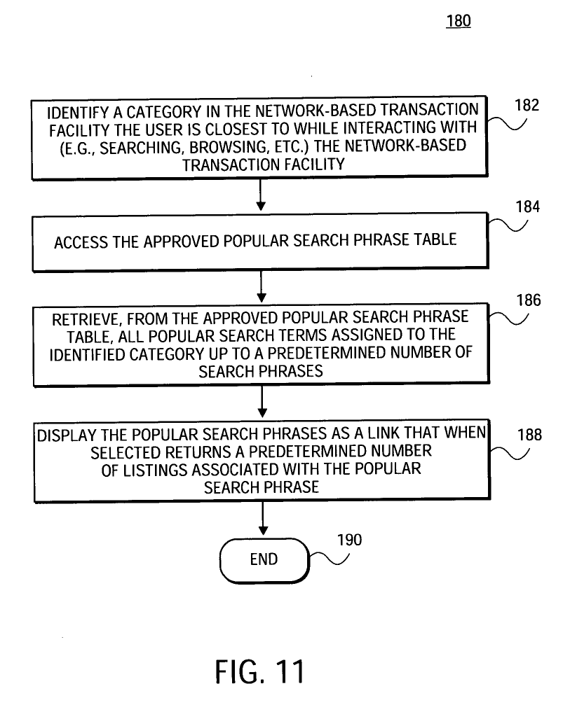

FIG. 11 is a flowchart illustrating a method 180, according to an exemplary embodiment of the present invention, of providing a user with the opportunity to view listings, for example, based on the supply and demand of the listings in the network-based commerce system 10.

At block 182, a category (or more than one category) in the network-based commerce system 10 is identified which is most closely related to an area or division of the system 10 within which the user is interacting (e.g., searching, browsing, etc.). In one embodiment, searches need not take place in a specific category. As a result, logic may be applied that will “guess” or ascertain what category within the network-based commerce system 10 is considered to be the most appropriate based on the user interaction.

An example of the assignment and identification of categories may be as follows when the popular search term or phrase is, for example, “paintball”:

Sports

Sporting Goods

Paintball

Other Items

Markers

Barrels

Protective Gear

Tanks

Other Sports

In one embodiment search terms corresponding to a category name are excluded. Thus, if a category name matches the search term, then the search term is excluded and thus not associated with that category and all children categories. Accordingly, in the present example, the popular search term “paintball” would only be associated with “Sports”, “Sporting Goods”, and “Other Sports” and the sub-category “Paintball” and its sub-category would be ignored.

At block 184, the Approved Popular Search Term table 170 is accessed.

At block 186, one or more popular search terms that are assigned to the category identified in block 182 are retrieved according to rank in ascending order up to a predetermined or selected number (e.g., 3) of popular search terms. In another exemplary embodiment, all popular search terms assigned to the category identified in block 182 are retrieved according to rank, in descending order, up to a predetermined number (e.g., 3) of popular search terms.

At block 188, the popular search terms are displayed as links that, when selected by a user, return a predetermined number of listings, each associated with the popular search term selected. In one exemplary embodiment, the listings are returned as hyperlinks on a web page. Upon selection of the respective hyperlink, the user may view listings associated with the link. At block 190, the method 180 ends.

FIG. 12A is a user interface 194, according to an exemplary embodiment of the present invention, to display selectable popular search phrases or terms to a user. The user interface 194 is in the form of a web page that presents groups of popular search terms that may be relevant to a user. The groups are displayed in an exemplary groups window 196. Within the groups window 196, the popular search terms displayed at block 188 of FIG. 11 are found under “Popular Searches”.

FIG. 12B illustrates an exploded view of the relevant groups window 196 included within the user interface 194 of FIG. 12A. In one embodiment, the “Popular Searches” section in the groups window 196 shows no more than the top three results and no less than two results.

As mentioned above, popular search terms or phrases may be ranked within categories based on the number of items that are returned when the popular search term is run against the database 30. An exemplary result in a “Consumer Electronics Category” may be ranked as follows:

1. Playstation 2 (5997)

2. DVD (5124)

3. Digital Camera (336)

4. iPod (55)

However, in one embodiment, even though users may search the term “DVD” more often than the term “Playstation 2”, the term “DVD” may have a lower ranking if there are fewer listings in that category associated with the popular search term or phrase. Accordingly, in one embodiment, the popular search terms or phrases are dependent upon supply or the number of listings provided that are associated with the search term. In particular, the ranking of the popular search phrases or terms would change over time as listings are added and removed from the network-based commerce system 10. For example, in a network-based action facility, as listings or items (e.g., products including goods and/or services) are sold, their associated listings would be removed from the inventory of listings and hence the suggested links (e.g. “Related Items”, “Popular Searches”, “Related Stores”, and/or any other listing related links) may vary based on supply (the number of current listings) as well as demand (because listings are removed once they have been sold). Thus, in general, the network-based commerce system 10 in one embodiment provides the user with listing recommendations based on economic principles of supply and demand. The listing recommendations may be based on the use of popular or frequently used search terms that are ranked, as described above.

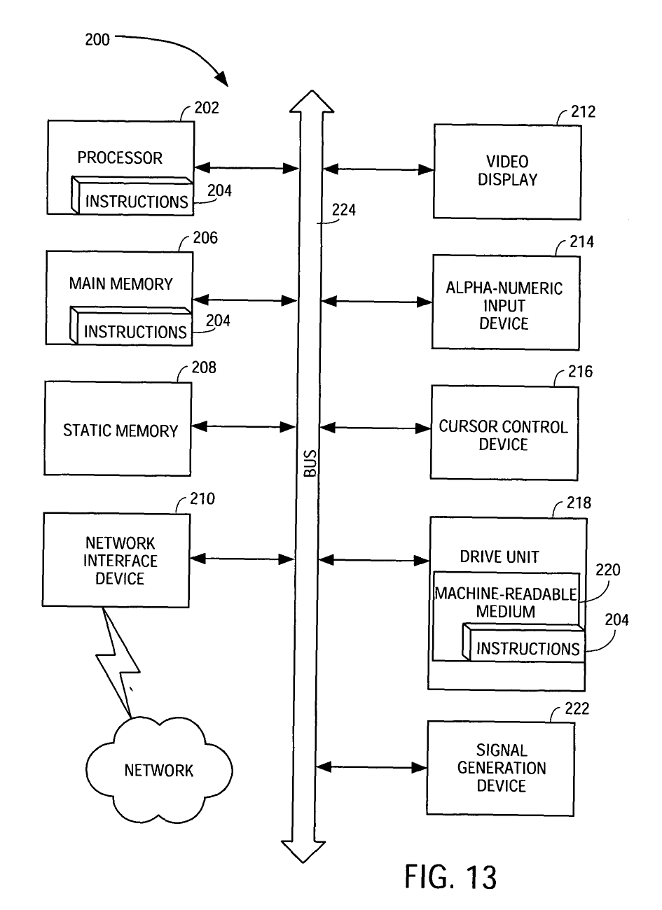

FIG. 13 shows a diagrammatic representation of a machine in the exemplary form of a computer system 200 within which a set or sequence of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance, set-top box (STB) or any machine capable of executing a sequence of instructions that specify actions to be taken by that machine.

The computer system 200 includes a processor 202, a main memory 206 and a static memory 208, which communicate with each other via a bus 224. The computer system 200 may further include a video display unit 212 (e.g., a liquid crystal display (LCD) or a cathode ray tube (CRT)). The computer system 200 also includes an alphanumeric input device 214 (e.g., a keyboard), a cursor control device 216 (e.g., a mouse), a disk drive unit 218, a signal generation device 222 (e.g., a speaker) and a network interface device 210.

The disk drive unit 218 includes a machine-readable medium 220 on which is stored a set of instructions or software 204 embodying any one, or all, of the methodologies described above. The software 204 is also shown to reside, completely or at least partially, within the main memory 206 and/or within the processor 202. The software 204 may further be transmitted or received via the network interface device 210. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Further, while the software is shown in FIG. 13 to reside within a single device, it will be appreciated that the software 204 could be distributed across multiple machines or storage media, which may include the machine-readable medium.

In the foregoing detailed description, the method and system of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. The present specification and figures are accordingly to be regarded as illustrative rather than restrictive.

What is claimed is:

1. A method of ranking search terms used in a network-based commerce system including a plurality of listings arranged in divisions, the method including:
retrieving frequently used search terms from a first memory location;
determining a number of listings in each division associated with each frequently used search term; and
ranking each frequently used search term based on the number of listings in each division.

2. The method of claim 1, which includes periodically adding new listings and removing terminated listings prior to determining the number of listings in each division associated with each frequently used search term so that the ranking is dependent upon supply and demand for the listings.

3. The method of claim 1, in which the divisions are categories, the method including ranking the frequently used search terms within each category.

4. The method of claim 1, which includes storing the ranked frequently used search terms in a second memory location in one of ascending and descending order, the frequently used search terms being identified from search terms used by a plurality of users of the network-based commerce system.

5. The method of claim 1, which includes determining if the frequently used search terms meet at least one predetermined criterion.

6. The method of claim 5, wherein the predetermined criterion is a minimum number of occurrences of listings in a division associated with the frequently used search term.

7. The method of claim 6, wherein the minimum number of occurrences of listings in a division is provided by a user selectable numeric value.

8. The method of claim 5, wherein the predetermined criterion is a minimum word length used in the search term.

9. The method of claim 5, wherein the predetermined criterion is that the frequently used search term does not correspond to a name of a division in the form of a category.

10. The method of claim 1, in which determining a number of listings in each division associated with each frequently used search term includes searching a database including the listings using each frequently used search term.

11. The method of claim 1, in which the frequently used search terms are sourced from a plurality of web sites.

12. The method of claim 11, wherein the web sites are located in a plurality of different countries, the method including identifying the frequently used search term according one of country, geography, language, and type of listing associated with the frequently used search term.

13. The method of claim 1, which includes determining if the frequently used search terms meet at least one predetermined criterion, the method including:
comparing the frequently used search terms against a list of reference words;
determining if any word of each frequently used search term corresponds to a word in the list of reference words; and
storing the frequently used search terms which do not include a word in the list of reference words for subsequent use.

14. The method of claim 13, which includes periodically updating the list of reference words.

15. A method of providing listing recommendations to users of a network-based commerce system including a plurality of listings arranged in a plurality of divisions, the method including:
identifying a division of the plurality of divisions based on user interaction with the network-based commerce system;
identifying at least one frequently used search term associated with the division; and
providing a link to the user to listings associated with the frequently used search term.

16. The method of claim 15, which includes communicating a web page to the user including a hyperlink to the listings associated with the frequently used search term.

17. The method of claim 15, in which the listings associated with the frequently used search term are listings that would be located if the user conducted a search of the network-based commerce system using the frequently used search terms.

18. The method of claim 15, wherein the predetermined number of frequently used search terms are ranked in one of an ascending and descending order according to a number of occurrences of listings in a division associated with the search term.

19. The method of claim 18, which includes periodically adding new listings and removing terminated listings prior to determining the number of listings in each division associated with each frequently used search term so that the ranking is dependent upon supply and demand for the listings.

20. The method of claim 15, which includes searching the network-based commerce system using at least one frequently used search term when the user selects the link.

21. The method of claim 15, wherein the frequently used search terms are displayed according to rank in one of an ascending and descending order.

22. The method of claim 15, wherein frequently used search terms are assigned to each of the plurality of divisions, the divisions being defined by categories.

23. A machine-readable medium embodying a sequence of instructions that, when executed by a machine, cause the machine to:
retrieve frequently used search terms from a first memory location of a network-based commerce system including a plurality of listings arranged in divisions;
determine a number of listings in each division associated with each frequently used search term; and
rank each frequently used search term based on the number of listings in each division.

24. The machine-readable medium of claim 23, wherein periodically new listings are added and terminated listings are removed prior to determining the number of listings in each division associated with each frequently used search term so that the ranking is dependent upon supply and demand for the listings.

25. The machine-readable medium of claim 23, wherein the divisions are categories and the frequently used search terms are ranked within each category.

26. The machine-readable medium of claim 23, wherein the frequently used search terms are sourced from a plurality of web sites located in a plurality of different countries.

27. A machine-readable medium embodying a sequence of instructions that, when executed by a machine, cause the machine to:
identify a division of a plurality of divisions based on user interaction with a network-based commerce system;
identify at least one frequently used search term associated with the division; and
provide a link to the user to listings associated with the frequently used search term thereby to provide listing recommendations a user.

28. The machine-readable medium of claim 27, wherein periodically new listings are added and terminated listings are removed prior to determining the number of listings in each division associated with each frequently used search term so that the ranking is dependent upon supply and demand for the listings.

29. A method of ranking search terms used in searching a database including a plurality of entries arranged in divisions, the method including:
retrieving frequently used search terms from a first memory location;
determining a number of entries in each division associated with each frequently used search term; and
ranking each frequently used search term based on the number of entries in each division.

30. A system to rank search terms used in a network-based commerce system including a plurality of listings arranged in divisions, the system including:
a frequently used search term retrieval module to retrieve frequently used search terms from a first memory location of the network-based commerce system;
a determination module to determine a number of listings in each division associated with each frequently used search term; and
a ranking module to rank each frequently used search term based on the number of listings in each division.

31. The system of claim 30, wherein periodically new listings are added and terminated listings are removed prior to determining the number of listings in each division associated with each frequently used search term so that the ranking is dependent upon supply and demand for the listings.

32. A system to provide listing recommendations to users of a network-based commerce system including a plurality of listings arranged in a plurality of divisions, the system including:
a division identification module to identify a division of a plurality of divisions based on user interaction with a network-based commerce system;
a frequently used search term identification module to identify at least one frequently used search term associated with the division; and
a display module to provide a link to the user to listings associated with the frequently used search term thereby to provide listing recommendations a user.

33. The system of claim 32, wherein periodically new listings are added and terminated listings are removed prior to determining the number of listings in each division associated with each frequently used search term so that the ranking is dependent upon supply and demand for the listings.

34. A system to provide listing recommendations to users of a network-based commerce system including a plurality of listings arranged in a plurality of divisions, the system including:
means to identify a division of a plurality of divisions based on user interaction with a network-based commerce system;
means to identify at least one frequently used search term associated with the division; and
means to provide a link to the user to listings associated with the frequently used search term thereby to provide listing recommendations a user.
